(19) United States
(12) Patent Application Publication
(10) Pub. No.: US 2008/0027687 A1
(43) Pub. Date: Jan. 31, 2008

(54) Process sequence modeling using histogram analytics

(75) Inventor: Bruce E. Aldridge, Oceanside, CA (US)

Correspondence Address: JAMES M. STOVER;TERADATA CORPORATION, 1700 SOUTH PATTERSON BLVD, WHQ5, DAYTON, OH, 45479, US

(73) Assignee: NCR Corporation

(21) Appl. No.: 11/495,388

(22) Filed: Jul. 28, 2006

(51) Int. Cl. G06F 17/10

(52) U.S. Cl. 703/2

(57) ABSTRACT

A computer-implemented method for modeling a process sequence, includes constructing the process sequence, wherein the process sequence includes one or more paths comprising one or more steps connecting the process sequence start with the process sequence finish, building at least one histogram model for each step, combining the histogram models for each step into an aggregated histogram model for each path, and combining the aggregated histogram models for each path into an aggregated histogram model for the process sequence.

### CROSS REFERENCE TO RELATED APPLICATIONS

This application is related to the following co-pending and commonly assigned patent applications:

U.S. patent application Ser. No. 10/742,966, filed on Aug. 9, 2004, by Bruce E. Aldridge and Rangarajan S. Thirumpoondi, entitled “System and Method for Tuning a Segmented Model Representing Product Flow Through a Supply Chain or Manufacturing Process,” attorneys' docket no. 11408; and

U.S. patent application Ser. No. 10/254,234, filed on Sep. 25, 2002, by Bruce E. Aldridge and Rangarajan S. Thirumpoondi; entitled “Analyzing a Supply Chain Based on a Segmented Representation of the Supply Chain,” attorneys' docket no. 10,998.10;

which applications are incorporated by reference herein.

### BACKGROUND OF THE INVENTION

1. Field of the Invention

This invention relates to process sequence modeling using histogram analytics.

2. Description of Related Art

Supply chain and manufacturing flows (herein referred to as process sequences) are characterized by a sequence of steps that transform, process, and physically move items from one location/step to a final location/step. The ability to model the entire sequence of steps in detail, while properly accounting for statistical variation, is important to a business in terms of planning, scheduling, commitments, and identification of unusual events, etc.

The organization and characterization of these sequential steps is complicated by the many possibilities and methods used for processing and moving items. For example, an item can be combined with other items, it may be split and sent to one or more processes or the sequence of steps can be changed to meet changing business needs. Modeling the entire sequence of steps is generally not possible with existing systems because of the complexities involved, so businesses are forced to model individual steps, small subsets or apply average trends to the overall system.

It is therefore highly desirable to provide a robust method for detailed modeling of complex supply chains and manufacturing process sequences that include estimation of possible outcomes (variability) and the likelihood of these results.

A flexible method of organizing, reporting and modeling the process sequences at a detailed level is needed to address various business problems, such as visibility, expected next steps, congestions, unusual excursions and ultimately the expected availability of the product at the end of the line. To be truly useful, this method must not only track the detailed transactions but be able to evaluate the effects of variability and process changes on the supply chain or manufacturing process.

The only known alternate viable solution to this problem is Monte Carlo simulation (MC). While MC simulations have proven useful, they tend to be cumbersome and tedious to set up. In addition, the accuracy of the MC solution is proportional to the number of runs, requiring large numbers of discrete runs to obtain acceptable accuracy. Changes in the process sequence will also require new MC setups and evaluations.

What is needed in the art is an improved method for detailed modeling of complex process sequences. Specifically, there is a need in the art for a method that performs such modeling while estimating possible outcomes and the likelihood of these results. The present invention satisfies that need.

### SUMMARY OF THE INVENTION

The present invention discloses a computer-implemented method for modeling a process sequence, which includes constructing the process sequence, wherein the process sequence includes one or more paths comprising one or more steps connecting the process sequence start with the process sequence finish, building at least one histogram model for each step, combining the histogram models for each step into an aggregated histogram model for each path, and combining the aggregated histogram models for each path into an aggregated histogram model for the process sequence.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention.

FIG. 2 illustrates a process sequence of five steps with multiple parallel paths.

FIG. 3 illustrates six of the ten possible paths for an item at step 1 to reach step 5.

FIG. 4 illustrates the combined models from FIG. 2, in the same order.

FIG. 5 is an example collection of segments, queues and interconnections.

FIG. 6 shows the segments from FIG. 5 with modeled path splits, lot splits and path mergers shown.

FIGS. 7A-7L are exemplary performance histograms showing cycle times for various segments along various paths.

FIG. 8 illustrates the effect of combining performance histograms for two serial segments.

FIGS. 9A and 9B illustrate the effect of combining performance histograms for two parallel segments with differing path loads.

FIG. 10 illustrates a normal performance histogram, with a cumulative probability plotted as a solid line on the secondary (right side) y axis.

FIGS. 11A-11D illustrate the distribution of probabilities from each bin in a skeleton histogram to an overlap merge bin.

FIG. 12 illustrates two serial histogram aggregations.

FIGS. 13A-13C illustrates two parallel histogram aggregations.

FIG. 14 is a flow chart illustrating the logic of the preferred embodiment of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1 Overview

The present invention introduces a novel application of histogram combination rules and a method that can be applied to a complex sequence of steps in order to build a model of the overall process in great detail. The method can handle a large numbers of steps, multiple paths, splits, merges and parallel paths to build a model of the sequences between any two points in the process, thus solving the problem of detailed modeling of a complex process sequence.

1.1 Hardware and Software Environment

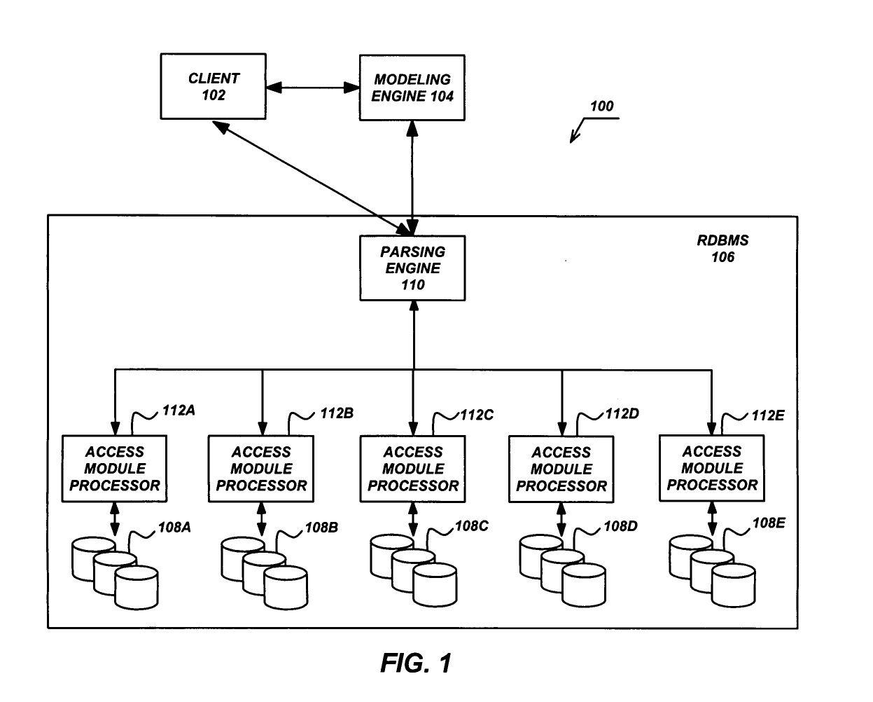

FIG. 1 illustrates an exemplary hardware and software environment according to the preferred embodiment of the present invention. In the exemplary environment, a computer system 100 implements a Modeling Engine Framework in a three-tier client-server architecture, wherein the first or client tier provides a Client 102 that provides an operator interface to the system 100, the second or middle tier provides a Modeling Engine 104 for performing functions as described later in this application, and the third or server tier comprises a Relational DataBase Management System (RDBMS) 106 that stores data and metadata in a relational database 108A-E. The first, second, and third tiers may be implemented in separate machines, or may be implemented as separate or related processes in a single machine. Moreover, alternative embodiments are not restricted to a 3-tier system, as the present invention may be implemented on all manner of computer systems.

In the preferred embodiment, the RDBMS 106 includes at least one Parsing Engine (PE) 110 and one or more Access Module Processors (AMPs) 112A-112E storing the relational database 108. The Parsing Engine 110 and Access Module Processors 112 may be implemented in separate machines, or may be implemented as separate or related processes in a single machine. The RDBMS 106 used in the preferred embodiment comprises the Teradata® RDBMS sold by NCR Corporation, the assignee of the present invention, although other DBMS's could be used.

Generally, the Client 102 includes a graphical user interface (GUI) for users of the system 100, wherein requests are transmitted to the Modeling Engine 104 and/or the RDBMS 106, and responses are received therefrom. In response to the requests, the Modeling Engine 104 performs the functions described below, including formulating queries for the RDBMS 106 and processing data retrieved from the RDBMS 106. Moreover, the results from the functions performed by the Modeling Engine 104 may be provided directly to the Client 102 or may be provided to the RDBMS 106 for storing into the relational database 108. Once stored in the relational database 108, the results from the functions performed by the Modeling Engine 104 may be independently retrieved from the RDBMS 106 by the Client 102.

Note that the Client 102, the Modeling Engine 104, and the RDBMS 106 may be implemented in separate machines, or may be implemented as separate or related processes in a single machine. For example, the system may comprise a two-tier client-server architecture, wherein the client tier includes both the Client 102 and the Modeling Engine 104.

Moreover, in the preferred embodiment, the system 100 may use any number of different parallelism mechanisms to take advantage of the parallelism offered by the multiple tier architecture, the client-server structure of the Client 102, Modeling Engine 104, and RDBMS 106, and the multiple Access Module Processors 112 of the RDBMS 106. Further, data within the relational database 108 may be partitioned across multiple data storage devices to provide additional parallelism.

Generally, the Client 102, Modeling Engine 104, RDBMS 106, Parsing Engine 110, and/or Access Module Processors 112A-112E comprise logic and/or data tangibly embodied in and/or accessible from a device, media, carrier, or signal, such as RAM, ROM, one or more of the data storage devices, and/or a remote system or device communicating with the computer system 100 via one or more data communications devices.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

1.2 General Description

The solution to the problem of generating a statistically accurate model of multiple process sequences starts by building detailed models of each individual step within the sequence. The process sequence flows are then identified (i.e., how the individual steps are interconnected in the supply/manufacturing line). A systematic methodology is then provided for combining the individual models associated with each step into a detailed aggregated model suitable for the overall process sequence.

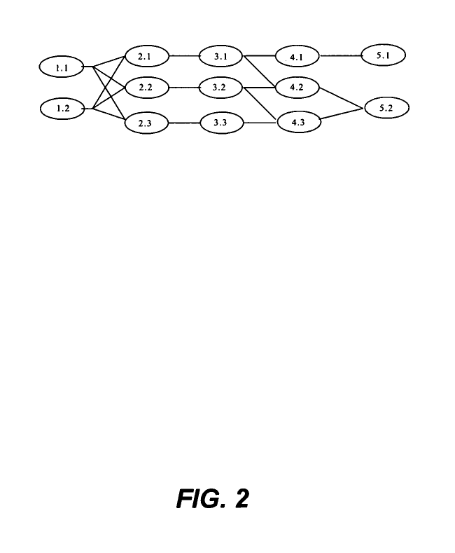

To illustrate, consider the sequence of steps shown in FIG. 2 (these steps could be supply chain logistics or manufacturing sequences). In FIG. 2, there is a sequence of five steps, with one or more paths between each step connecting the end of one process (oval) with the beginning of the next, from left to right.

Each step is represented by one or more ovals, wherein each oval represents a process, and each process may be comprised of one or more sub-processes.

In FIG. 2, each oval has a Cartesian coordinate comprised of “skey.pkey” values (skey is a serial key value and pkey is a parallel key value). Consequently, each process is assigned an skey and pkey, in order to indicate their position in the supply chain, namely, 1.1, 1.2, 2.1, 2.2, 2.3, 3.1, 3.2, 3.3, 4.1, 4.2, 4.3, 5.1 and 5.2 in FIG. 2.

The sequence of FIG. 2 includes multiple parallel paths (e.g., 2.1→3.1, 2.2→3.2 and 2.3→3.3), splits (e.g., 1.1→{2.1, 2.2 and 2.3}) and merges (e.g., {4.1, 4.2} →5.2). Associated with each step is a model for cycle time and/or yield (not shown), which will be described in more detail below.

In the present invention, the Modeling Engine 104 performs the following steps for the process sequence:

1. Detailed models of each sequence are built and stored in histogram form. See, for example, the discussion in the co-pending and commonly-assigned U.S. patent application Ser. No. 10/742,966, filed on Aug. 9, 2004, by Bruce E. Aldridge and Rangarajan S. Thirumpoondi, entitled “System and Method for Tuning a Segmented Model Representing Product Flow Through a Supply Chain or Manufacturing Process,” attorneys' docket no. 11408, which application is incorporated by reference herein.

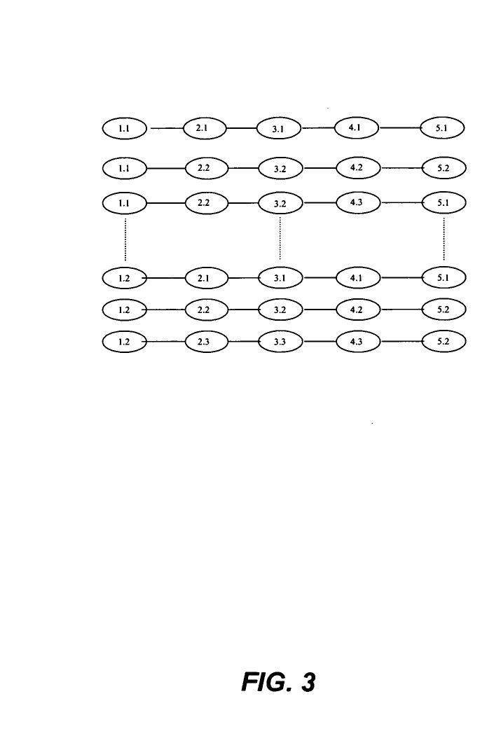

2. The possible paths between start and finish are enumerated using a method of path decomposition. FIG. 3 shows a partial result of this path decomposition as applied to the sequence of FIG. 2, wherein FIG. 3 illustrates 6 of the 10 possible paths for an item at step 1 to reach step 5. Associated with each path are the relative probabilities of taking that path (not shown), which will be described in more detail below.

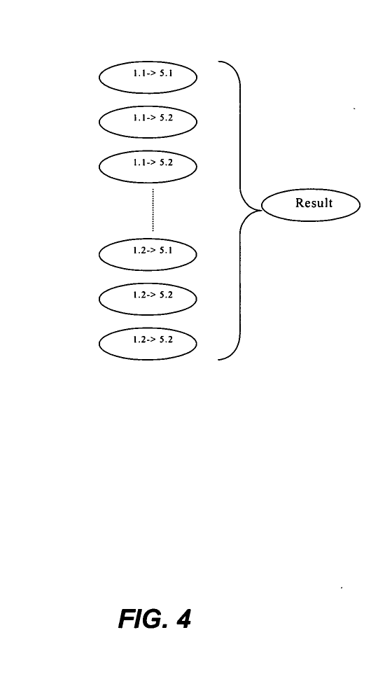

3. The histograms for each step are then statistically combined and weighted in series to form a single probability based histogram for each possible path, as shown in FIG. 4. FIG. 4 illustrates the combined models from FIG. 3 (in the same order), represented by an oval containing the path descriptor, namely 1.1→5.1, 1.2→5.2, 1.1→5.3, . . . , 1.2→5.1, 1.2→5.2, 1.2→5.3. Each oval in FIG. 4 is associated with a single model histogram representing the time and/or yield for an item traversing that particular path. Also associated with these models are the relative probabilities of each path (from FIG. 3).

4. The histogram per path results are then combined in a parallel methodology to form a single, statistically accurate, model. For example, in FIG. 4, the 10 individual results are merged to a single “Result” oval as shown.

This solution can be applied between any two points of the process sequence with some additional rules, allowing for arbitrary model building. In addition, the accuracy of the solution can be increased or reduced as necessary by increasing or reducing the number of bins in the histogram models.

From the resulting histogram, detailed statistics are obtainable, including expected values (e.g., average lead time, average yield), range of values (min, max, median, quartiles, deciles), statistical functions (standard deviation, skew, kurtosis) and probability densities/cumulative probabilities (e.g., what is the probability of observing a value range?).

A more detailed description of how the Modeling Engine 104 performs these steps is provided in the sections set forth below.

1.3 The Supply Chain/Manufacturing Sequence

In one example, the process sequences may represent, but are not limited to, a supply chain or manufacturing sequence. Transactional systems generate large amounts of facts about entities in the supply chain. Because of the sequential nature of these transactions, they can generally be arranged into a time based series of events applicable to items in the supply chain. Furthermore, later movements through the same supply chain can be expected to follow the same events with similar results for times and quantities. This suggests that consistent models can be built at a detailed level.

1.4 Reporting and Analysis

There are essentially three types of analyses that are required (past, present and future):
What happened to get to the current state?
What is the current state?
Based on the current state, what is likely to happen going forward (and what can I do to change or capitalize on this)?

1.4.1 What is Happening Now and What has Happened?

Structured organization of the supply chain provides a way of reporting current status of where everything is and how items have progressed through the chain historically (“what is happening” and “what has happened”).

This reporting is somewhat analogous to reporting vehicle positions based on highway numbers and mileage markers as a function of historical time. Only users familiar with the system are able to evaluate if things are approximately where they should be and if they are moving appropriately.

1.4.2 What Will Happen?

Much of the experience required to properly interpret the visibility reports (what is/has happened) can be built into models and used to make and evaluate predictions about what will happen. By building a system to automatically model the distribution of times and yields between two adjacent events in the chain, a user or the system can compare detailed movements against the model to determine if expected progress is being made. Scoring can be made depending on the level of any observed disparities and the relative value of the product to alert the user to situations that need resolution.

By pushing projections across multiple segments, the models can be combined to provide predicted positions and possible completion time/quantities. This projection based on current positions (e.g., what will happen) provides the ability of automatic detection and early warning when the predictions are not likely to match the requirements.

1.5 The Problem of Variability

There would be little need for such advanced modeling of the supply chain if everything behaved exactly the same, time after time. With no variability in movements of the chain, exact plans, loading and delivery schedules could be readily built and adhered to.

Unfortunately, virtually all processes experience both planned (work schedules, maintenance) and unplanned variability (breakdowns, influence of other factors). Because of variability, the supply chain will perform at less than optimum and generally experience one or more of the following:
an increase in inventory/work in progress,
an increase in (overall) time through the chain,
a decrease in throughput, and
a required increase in capacity of the chain or arising bottlenecks if capacity is not increased.

In terms of evaluation of historical movements, a method is necessary to determine if something is truly unusual or could be expected based on the observed positions and the observed and/or expected level of variability. It is therefore critical to understand and model variability to drive any supply chain/manufacturing sequence towards improvement.

2 The Approach of the Present Invention

The Modeling Engine 104 of the present invention provides the following approach:
Organize the process sequence into sequential steps based on available data transactions and logical requirements.
Define (expected) paths through the sequence with probabilities.
Define event-to-event models for cycle time and/or yield.
Aggregate the models over multiple steps, according to the expected paths, to evaluate performance and generate predictions.

2.1 Organization of the Supply Chain—Events, Segments and Queues

2.1.1 Events

As transactional data is collected, the transactions can be used to demarcate the beginning and end of processes. This suggests defining a segment as the process interval between appropriate data collection events.

In this context, a data collection event must contain the following:
a timestamp of the event,
items observed (e.g., shipments, products), and
location in the supply chain (e.g., physical, logical, equipment).

This “point in time” collection of information is termed an event. Events can be defined from most transactional systems in use such as shop floor systems, warehouse systems, logistics systems and shipping.

2.1.2 Segments

A segment is then defined as the process between two significant sequential events. The segment process should be thought of in a very general way. It could represent a physical transformation (e.g., manufacturing), a movement (e.g., logistics), verification (e.g., testing, inspection) or other activities. Note that with these definitions, manufacturing activities and supply chain effectively have the same structure.

Identification of a segment is then associated (at a minimum) with the starting event and ending event. In some cases it may be advantageous to include attributes of the items within the segment, although these can frequently be included in the event definitions or handled independently with the item management (see Section 2.2).

2.1.3 Queues

The end event of a segment may correspond to the starting event of the next segment. For example, a transaction of a truck in-yard will generally begin the next process, that of docking. In these cases, there are no queues or other inventory hold locations between the segments.

Frequently, however, the end of one segment will not correspond to the beginning of the next. In this case, a queue will exist where products are temporarily held while awaiting the start of the next segment. Effectively, a queue has its own start and end events corresponding to the end event of the last segment and the start event of the next, respectively. A queue is modeled differently from a segment, however, in that the cycle time of a queue is generally a function of the number of items in a queue and the processing rate of the next process.

Analysis of queues in the supply chain is closely related to capacity constraints and is the subject of current research.

2.1.4 Sequences and Paths

The connection of segments to other segments and queues forms paths that are consistent with the sequence of processing. The paths can be thought of much as a roadmap, connecting segment to segment and allowing for splits and merges between steps (e.g., parallel processing on components of an item). An important concept required by the methodology outlined herein is the requirement to weight the paths, such that an expected load on a process or predicted path can be made. This is equivalent to assigning probabilities at splits (probabilities are not needed at merges).

2.1.5 Channels

A channel is a collection of independent paths. Channels are essentially independent analyses as there are generally no allowed interconnections between channels (although the ending point of one channel can be the starting point of another when traceability is totally lost, as well as other options such as treating the location as a queue).

2.2 Set of Goods

Moving from event to event through the supply chain are sets of goods. These are items that are tracked through the events and segments. Some expected characteristics of the set of goods as it progresses include:
Different tracking identifications may be used, depending on the segment/process/channel.
Unit of measure changes may occur (e.g., many to few, or few to many, or change of name).
Consolidation or “break up” (e.g., multiple packages into crate, or truckload to multiple pallets).
Virtual vs. real items (e.g., tracking order status vs. actual shipments).

For the present invention, the set of goods can influence the path selection. For example, in semiconductor manufacturing, a lot (i.e., set of goods) that passes testing at a very high speed may require different packaging to handle the expected heat and use profiles. Once the result of the test is known, the specific path for that lot can be selected. Prior to test, the user has a choice of approximating the possibility of the lot testing to high speed or terminating the projection at test.

Similarly, it is expected that other attributes associated with the set of goods could influence cycle time performance in a segment. Currently, the models only allow these attributes to be categorical variables (e.g., small, medium, large) and it is handled with separate parallel segments or paths for each.

2.3 Metrics

2.3.1 Historical Metrics

Using the organization of the supply chain based on events, segments, paths, set of goods, etc., many “standard” metrics can be applied for business intelligence reporting. Metrics such as fulfillment, perfect orders, shipping times, etc., have been well documented and will not be discussed in detail herein.

2.3.2 Predictive Metrics

Using the structured arrangement of events, segments and paths, only three detailed metrics are used for all analytical predictions. These are:
Location of items: current or last known location of all items of interest, effectively identifying the segment or queue within the path/channel.
This metric is used with cycle time, yield and path selection models to establish the boundaries for prediction.
Quantity of items tracked into the current segment (used with yield model for predicting output quantity).
Time of last event (used with cycle time model for predicting completion time).

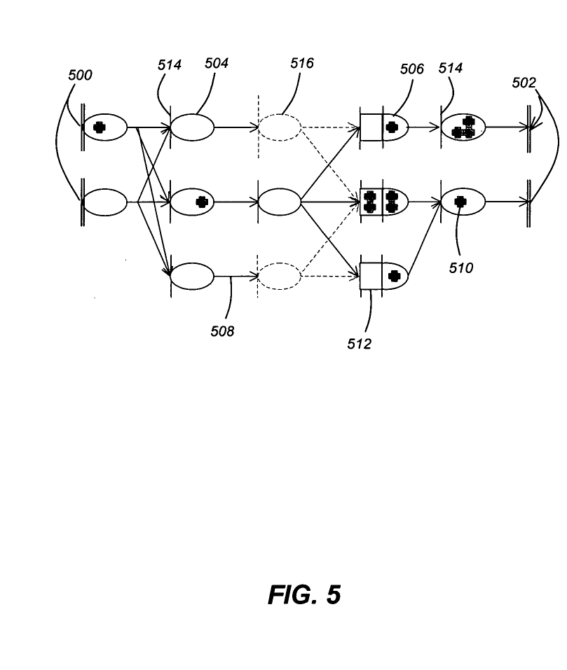

FIG. 5 illustrates a collection of events, segments, queues and items in a hypothetical supply chain comprised of a single channel, 14 possible paths through 13 segments (with 3 queues).

In FIG. 5, the double vertical bars 500 on the left indicate start events, while the double vertical bars 502 on the right indicate end events.

The ovals 504 and half-ovals 506 represent processes 504, 506, while the arrows 508 represent interconnections 508.

The crosses 510 within the ovals 504 or half-ovals 506 represent items 510 in process 504, 506.

The rectangles 512 attached to the half-ovals 506 represent queues 512, wherein the crosses 510 within the rectangles 512 represent items 510 in queues 512.

A standard segment comprises: (1) all objects between a double vertical bar 500 and a single vertical bar 514, (2) all objects between two single vertical bars 514, and (3) all objects between a single vertical bar 514 and a double vertical bar 502.

A null segment is indicated by an oval 516 in dashed outline, along with one or more vertical bars 514 in dashed outline.

In a segment with a queue 512, the queue 512 starts after the previous process but before the next process' start event, as indicated by the vertical bar 514 between the queue 512 and the half-oval 506.

3 Analytical Solutions

This Section describes the overall approach to modeling the supply chain and predicting yield, cycle time and location metrics.

3.1 Building the Segments and Paths

3.1.1 Events

Events are generally identified directly from the transactional systems. This is done either by tracing the sets of goods through the processes or through expert user knowledge of the system.

3.1.2 Segments/Queues/Paths

Segments (and queues) can be derived from the event to event sequencing of sets of goods. While both segments and queues are defined as the interval (process) between two sequential events, the analytical models are different for a process segment than for a queue. It is therefore necessary to explicitly identify queues, based on the likelihood of inventory being held at the queue prior to processing.

Evaluation of the event to event data also provides information about the paths and interconnections (connections between segments). As paths split and merge, historical data will typically be used to estimate the probability of a split.

Note that there are two distinct types of splits:
Path splits—In this case, the set of goods is kept intact and a selection of one or more paths is made. This is equivalent to selecting a specific road when presented with two or more roads at an intersection.
Lot splits—In this case, the individual components in the set of goods are physically split and proceed on different paths. This is analogous to a single passenger load splitting into multiple aircraft at a hub.

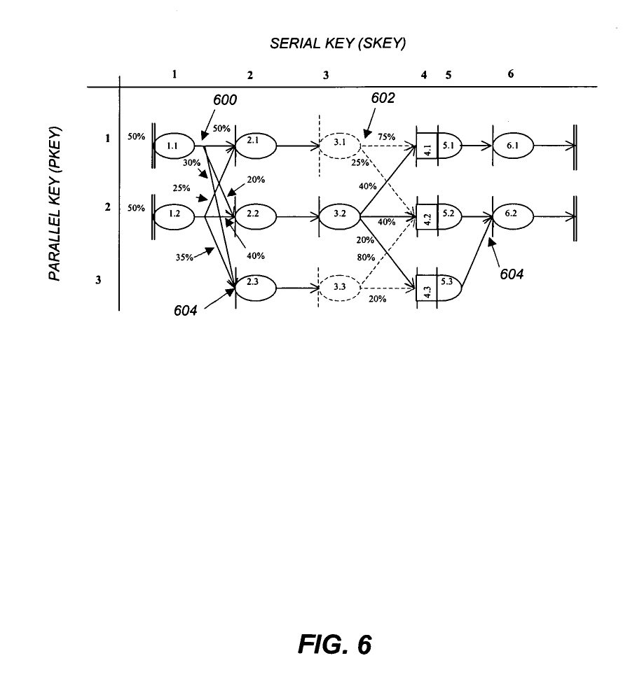

FIG. 6 shows the example of FIG. 5 with path splits 600, lot splits 602 and path merges 604 identified. Because the segments in FIG. 6 are connected (no isolation exists), there can only be one channel. Note the percentages assigned to the splits and types of splits. Note also the 50% at the start event to indicate equal loading of two possible start segments.

3.1.2.1 Segment Alignment and Organization

The solution outlined in Section 4 requires alignment of segments between paths. Essentially, this means that all paths from one point to another point (e.g., beginning to end) must have the same number of segments.

Clearly, this will not always be the case for physical segments. A simple example is a step where samples are selected for inspection. Some sets of goods are delayed for inspection while others skip the step.

Null segments are introduced as placeholders to keep the analytics synchronized in terms of numbers of segments in a path. FIG. 6 shows some of the segments as null segments (segments 3,1 and 3,3 indicated with dashed outlines). Null segments are characterized by virtual (non-existent events and trivial pass-through models (100% yield, no variability or 0 cycle time, no variability). Their function is simply as a placeholder for synchronization.

3.1.2.2 Cartesian Identification

While the segment, event and queue definitions are based on business attributes of the supply chain, it is necessary to have a structured layout of segments and events to allow analysis.

As noted above, the method used in the present invention is based on Cartesian coordinates. Consequently, each process, queue and segment is assigned an skey and pkey, in order to indicate their position in the supply chain. As shown in FIGS. 2-6, the Cartesian numbering of processes and queues is “skey.pkey,” while the corresponding segments, which includes all objects between events, are referred to as “skey, pkey” (not shown).

In this manner, the segments, processes, and queues can be uniquely identified, and positioned in sequence, with splits and merges defined. The “skey, pkey” or “skey.pkey” combinations can then be used as a foreign key to index the business attributes stored in the RDBMS 106 that are associated with the segments, processes, queues and events.

FIG. 6 shows the skey and pkey assignments associated with FIG. 5.

3.2 Segment Models

Once the events, segments and connections have been set up, the analytical tables can be built.

3.2.1 Path Table

The path table contains all of the interconnections between segments. An example based on FIG. 6 is shown in Table 1 below. Note that Table 1 is specified in terms of last segment (skey, pkey) and next segment (skey, pkey). Also associated with this table are:
Start and end segments (last segment skey=0 for start, next segment skey

=0 for end).
Splits (path splits and lot splits. Because a lot split implies a path split, the table is constrained to be one or the other).
Null segment identification.
Queue segment identification.
Segments which allow performance modification (not shown).
Performance model associated with the segment (associated with skey, pkey, queue and null segment in Table 1—also see Section 3.2.3).
Channel identification (not shown).

TABLE 1
Representation of segment interconnections of FIG. 6.

| | Segment | Segment | Segment | | | | |
|---|---|---|---|---|---|---|---|
| Segment | in | Out | Out | | | | |
| in Serial | Parallel | Serial | Parallel | | Path | | Null |
| Key | Key | Key | Key | Lot Split | Split | Queue | Segment |
| 0 | 0 | 1 | 1 | 1 | 0.5 | 0 | 1 |
| 0 | 0 | 1 | 2 | 1 | 0.5 | 0 | 1 |
| 1 | 1 | 2 | 1 | 0.5 | 1 | 0 | 0 |
| 1 | 1 | 2 | 2 | 0.2 | 1 | 0 | 0 |
| 1 | 1 | 2 | 3 | 0.3 | 1 | 0 | 0 |
| 1 | 2 | 2 | 1 | 0.25 | 1 | 0 | 0 |
| 1 | 2 | 2 | 2 | 0.4 | 1 | 0 | 0 |
| 1 | 2 | 2 | 3 | 0.35 | 1 | 0 | 0 |
| 2 | 1 | 3 | 1 | 1 | 1 | 0 | 0 |
| 2 | 2 | 3 | 2 | 1 | 1 | 0 | 0 |
| 2 | 3 | 3 | 3 | 1 | 1 | 0 | 0 |
| 3 | 1 | 4 | 1 | 1 | 0.75 | 0 | 1 |
| 3 | 1 | 4 | 2 | 1 | 0.25 | 0 | 1 |
| 3 | 2 | 4 | 1 | 1 | 0.4 | 0 | 0 |
| 3 | 2 | 4 | 2 | 1 | 0.4 | 0 | 0 |
| 3 | 2 | 4 | 3 | 1 | 0.2 | 0 | 0 |
| 3 | 3 | 4 | 2 | 1 | 0.8 | 0 | 1 |
| 3 | 3 | 4 | 3 | 1 | 0.21 | 0 | 1 |
| 4 | 1 | 5 | 1 | 1 | 1 | 1 | 0 |
| 4 | 2 | 5 | 2 | 1 | 1 | 1 | 0 |
| 4 | 3 | 5 | 2 | 1 | 1 | 1 | 0 |
| 5 | 1 | 6 | 1 | 1 | 1 | 0 | 0 |
| 5 | 2 | 6 | 2 | 1 | 1 | 0 | 0 |
| 5 | 3 | 6 | 2 | 1 | 1 | 0 | 0 |
| 5 | 1 | 0 | 0 | 1 | 1 | 0 | 0 |
| 5 | 2 | 0 | 0 | 1 | 1 | 0 | 0 |

Start and end segments are defined with skey = 0, pkey = 0.
Lot splits, path splits, queues and null segments are explicitly shown.
Note that a queue is not allowed with a null segment and a path split is not allowed with a lot split.

Construction of this table is based on the techniques discussed in Section 5.2.1 and may be accomplished with various tools and expert knowledge. Building this table is discussed in the co-pending and commonly-assigned U.S. patent application Ser. No. 10/742,966, filed on Aug. 9, 2004, by Bruce E. Aldridge and Rangarajan S. Thirumpoondi, entitled “System and Method for Tuning a Segmented Model Representing Product Flow Through a Supply Chain or Manufacturing Process,” attorneys' docket no. 11408, which application is incorporated by reference herein.

3.2.2 Segment Descriptions

As described in Sections 2.1 and 3.1, each segment is associated with start and end events and the sequence of the segment in the supply chain (using the skey, pkey nomenclature),

In addition, each segment must be associated with a performance model as discussed in the next Section. These requirements suggest a segment information table as shown in Table 2. This table contains information on the events, whether the segment has a queue and the performance model to use for the segment.

TABLE 2
Illustration of a possible segment information table.

| | | Start | End | Cycle Time | Yield |
|---|---|---|---|---|---|
| Segment | Segment | Event key | event | Performance | Performance |
| skey | pkey | (fk) | key (fk) | Key | Key |
| 1 | 1 | 123 | 275 | 1 | 6792 |
| 1 | 2 | 124 | 275 | 1 | 6791 |
| 2 | 1 | 275 | 308 | 21 | 0 |
| 2 | 2 | 275 | 313 | 22 | 0 |
| 2 | 3 | 275 | 341 | 23 | 0 |
| 3 | 1 | 3080 | 308 | 0 | 0 |
| 3 | 2 | 313 | 472 | 9681 | 0 |

Note the use of 0 for performance keys for Null cycle time (0 time, no variability) and null yield (100% yield, no variability). Also note that the null segment has both start and end events the same.

3.2.3 Segment Performance Model Table

Each segment has a model built to predict the cycle time performance and/or yield performance. This table is built using historical data and tools to estimate the probability density as a function of time/yield. Description and use of this tool is described in another document.

Table 3 shows a representative structure of the performance model (partial rows shown). Each segment references a performance model key. The actual values stored in the model are in the form of a probability histogram. Typically, between 10 and 100 bins will be used to divide up the range of possibly cycle times or yields. Each bin will have a probability associated with the likelihood of observing values in that bin. For convenience, the bin midpoints are also stored to improve performance. Note that the null bin would typically have a single entry of 0 cycle time and 100% yield.

TABLE 3
Histogram representation of performance key 1.

| Performance | Bin | Bin | Bin | Bin | Bin |
|---|---|---|---|---|---|
| Key | Number | Beginning | End | Midpoint | Fraction |
| 1 | 1 | 2.36 | 2.52 | 2.44 | 0.0001 |
| 1 | 2 | 2.52 | 2.67 | 2.59 | 0.0003 |
| 1 | 3 | 2.67 | 2.82 | 2.75 | 0.0006 |
| 1 | 4 | 2.82 | 2.98 | 2.9 | 0.0010 |
| 1 | 5 | 2.98 | 3.13 | 3.05 | 0.0017 |
| 1 | 22 | 5.59 | 5.74 | 5.66 | 0.0500 |
| 1 | 23 | 5.74 | 5.89 | 5.82 | 0.055 |
| 1 | 24 | 5.89 | 6.05 | 5.97 | 0.059 |
| 1 | 25 | 6.05 | 6.2 | 6.12 | 0.063 |
| 1 | 26 | 6.20 | 6.35 | 6.28 | 0.063 |
| 1 | 43 | 8.81 | 8.96 | 8.89 | 0.0017 |
| 1 | 44 | 8.96 | 9.12 | 9.04 | 0.0010 |
| 1 | 45 | 9.12 | 9.27 | 9.2 | 0.0006 |
| 1 | 48 | 9.58 | 9.73 | 9.66 | 0.0003 |
| 1 | 50 | 9.89 | 10.04 | 9.96 | 0.0001 |

Each segment in a supply chain representation will be linked to a performance key and then to the detailed bin structure as shown

Use of these performance histograms is the subject of Section 4 and will be dealt with through examples.

3.2.4 Projection Tables

The performance table specified in Section 3.2.3 serves to provide projection analytics for the current segment (e.g., the segment the set of goods is currently in). These histograms can be used to predict yield and cycle time for the current segment based on the methods of Section 5.

Because of the complexity of histogram analytics, additional tables are typically pre-computed and used to make projections beyond the current segment (e.g., from current location to the end of the supply chain).

3.2.4.1 Path Decomposition Table

The path table (Table 4) is formed by the histogram analytics described in Section 4.2.4. This table contains all possible paths found in a given channel. Each path has a unique id and an estimate of the expected “load” on the path. For example, Table 4 lists some of the 14 possible paths and the expected load at each point in the path, as given in the column labeled (Path_Pct). Note that the expected load is based on split probabilities as defined in the path table (Table 1).

TABLE 4
Path decomposition table for structure of FIG. 6 (only 1^{st} 3 paths
shown).

| | | Start | End | End | Cur | Cum | |
|---|---|---|---|---|---|---|---|
| Path ID | Start Skey | Pkey | Skey | Pkey | Path % | Path % | Cum_Path_String |
| 1 | 0 | 0 | 1 | 1 | 0.5 | 0.5 | 1.1 |
| 1 | 1 | 1 | 2 | 1 | 0.5 | 0.25 | 1.1–2.1 |
| 1 | 2 | 1 | 3 | 1 | 1 | 0.25 | 1.1–2.1–3.1 |
| 1 | 3 | 1 | 4 | 1 | 0.75 | 0.1875 | 1.1–2.1–3.1–4.1 |
| 1 | 4 | 1 | 5 | 1 | 1 | 0.1875 | 1.1–2.1–3.1–4.1–5.1 |
| 1 | 5 | 1 | 6 | 1 | 1 | 0.1875 | 1.1–2.1–3.1–4.1–5.1–6.1 |
| 2 | 0 | 0 | 1 | 1 | 0.5 | 0.5 | 1.1 |
| 2 | 1 | 1 | 2 | 1 | 0.5 | 0.25 | 1.1–2.1 |
| 2 | 2 | 1 | 3 | 1 | 1 | 0.25 | 1.1–2.1–3.1 |
| 2 | 3 | 1 | 4 | 2 | 0.25 | 0.0625 | 1.1–2.1–3.1–4.2 |
| 2 | 4 | 2 | 5 | 2 | 1 | 0.0625 | 1.1–2.1–3.1–4.2–5.2 |
| 2 | 5 | 2 | 6 | 2 | 1 | 0.0625 | 1.1–2.1–3.1–4.2–5.2–6.2 |
| 3 | 0 | 0 | 1 | 1 | 0.5 | 0.5 | 1.1 |
| 3 | 1 | 1 | 2 | 2 | 0.2 | 0.1 | 1.1–2.2 |
| 3 | 2 | 2 | 3 | 2 | 1 | 0.1 | 1.1–2.2–3.2 |
| 3 | 3 | 2 | 4 | 1 | 0.4 | 0.04 | 1.1–2.2–3.2–4.1 |
| 3 | 4 | 1 | 5 | 1 | 1 | 0.04 | 1.1–2.2–3.2–4.1–5.1 |
| 3 | 5 | 1 | 6 | 1 | 1 | 0.04 | 1.1–2.2–3.2–4.1–5.1–6.1 |

Note that the start skey and end skey always differ by one in this table. This is a result of the Cartesian structure and the use of null segments to force alignment. Also, the relationship between a queue (e.g., segment 4,1) and the subsequent segment does not allow splits or merges.

Table 4 also contains a string of the path sequence. As expected, this is primarily for convenience to uniquely identify where the current segment is in the possible paths. Using this field, combined with the cumulative path load, allows for aggregation of loads at any point in the supply chain. (For example, the sum of cum_Path for the unique cum_path_string for a given skey should add up to 1.0).

3.2.4.2 Projection Tables (Cycle Time/Yield)

Because of the complexity of the histogram analytics, a separate table is recommended to maintain projections from one segment to another segment (typically the end point). This table has similar structure to Table 2 (performance model table) with the addition of the from/to segments.

3.3 Configuration Summary

This section provides an overview of how a supply chain (or manufacturing process) can be organized into events, segments, paths and channels. A segment path table is used to provide predictive information on which paths are the most likely and what the expected path load is. Associated with each segment are performance models (yield or cycle time). Using the performance models with the expected paths allows computation of predictions for the entire supply chain. The methodology of these predictions is described in the next Section.

4 Histogram Analytics

Histogram analytics is a methodology for predicting path, time and quantity in the supply chain. It incorporates variability and is able to provide confidence estimates as well as expected upper and lower bounds.

Histogram analytics are necessary to deal with complex routings and variations in sets of goods in the supply chain (and manufacturing). Because of the complexities in splits, merges, unit of measure changes, etc., there is generally no exact solution to these problems. While Monte Carlo (MC) simulations are frequently used to simulate complex problems with variability, MC simulations are difficult to set up and require many hundreds or thousands of runs to adequately model a single path.

Section 5 and beyond illustrate in detail how histogram analytics are used to make projections given the structures described previously (in Section 3) typically illustrated with the example from FIGS. 5 and 6.

4.1 Setup

As noted above, FIG. 6 illustrates a simple supply chain comprised of 11 physical segments and 3 queues. The segments are described using the Cartesian nomenclature of (skey, pkey), requiring the insertion of 2 null segments (3,1 and 3,3) to maintain correct synchronization. Interconnections between the segments and expected splits (path and lot) are also shown in FIG. 6, as well as documented in Table 1.

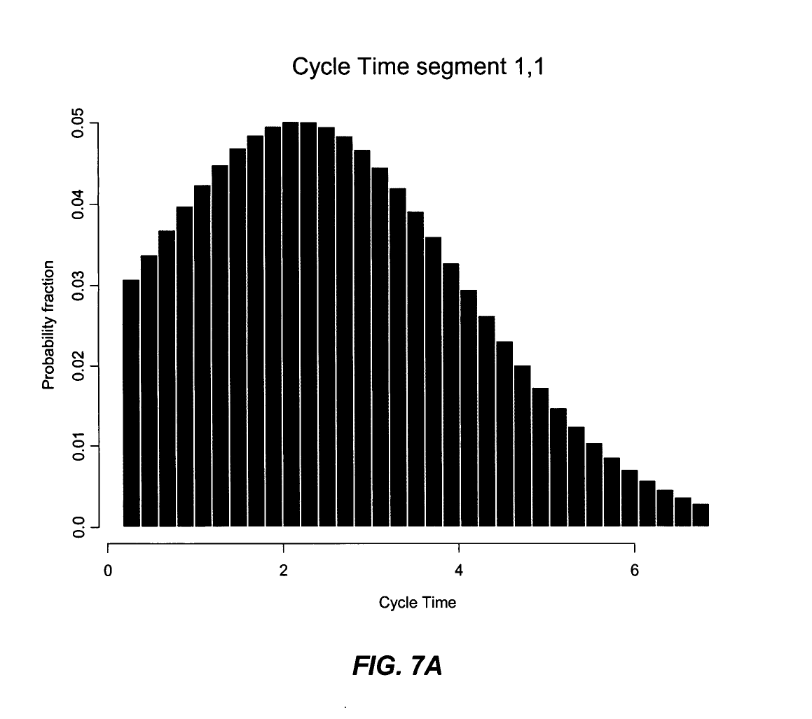

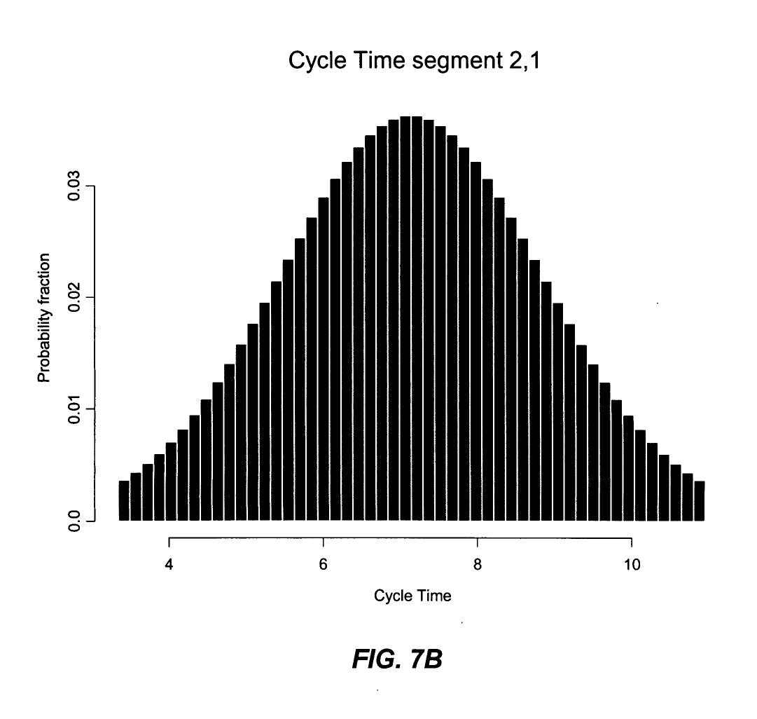

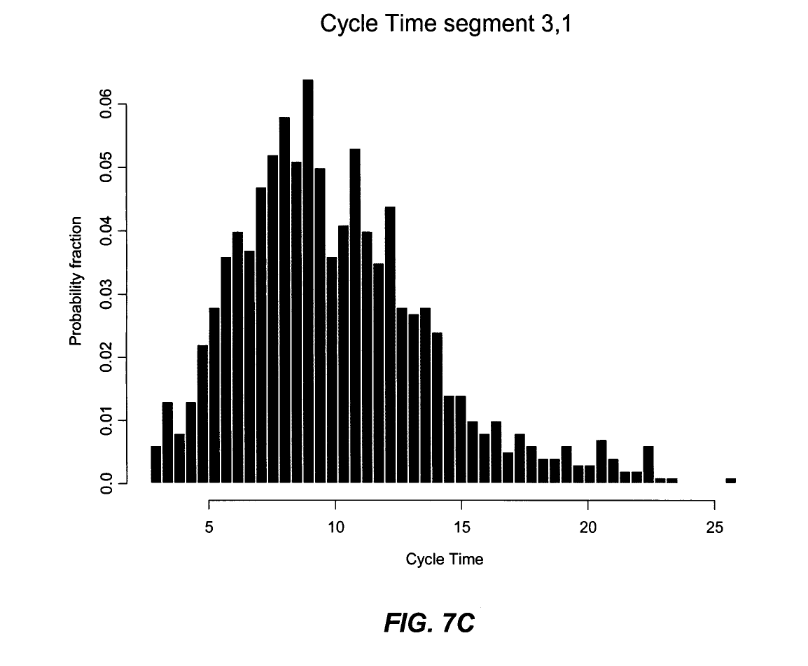

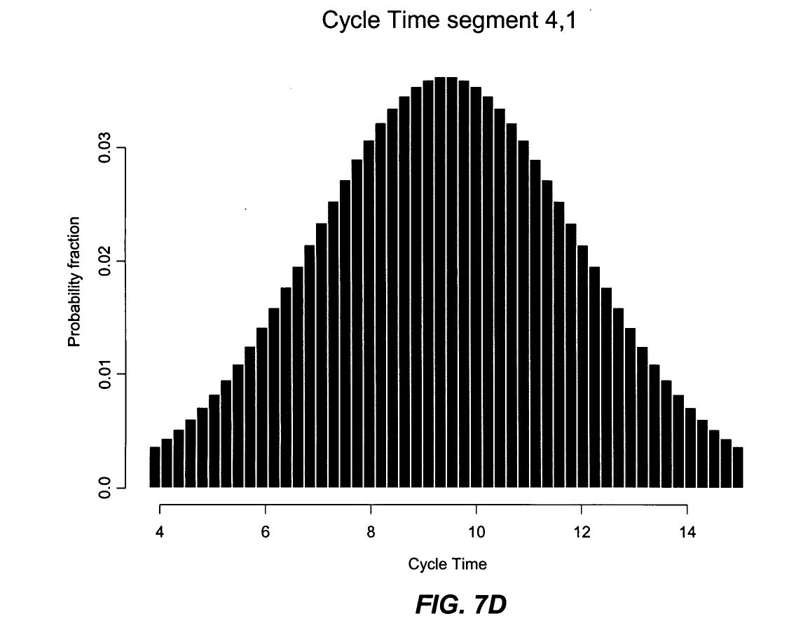

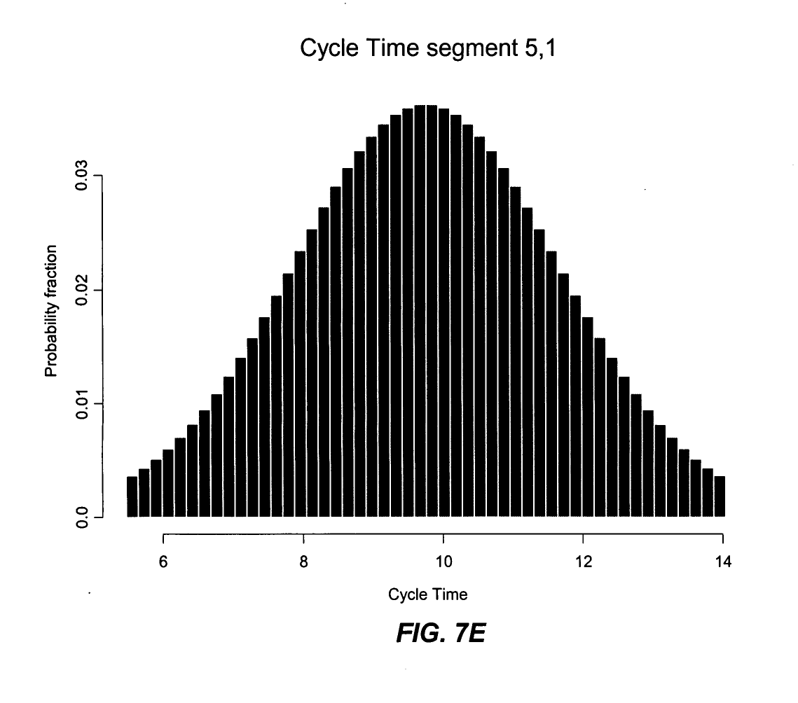

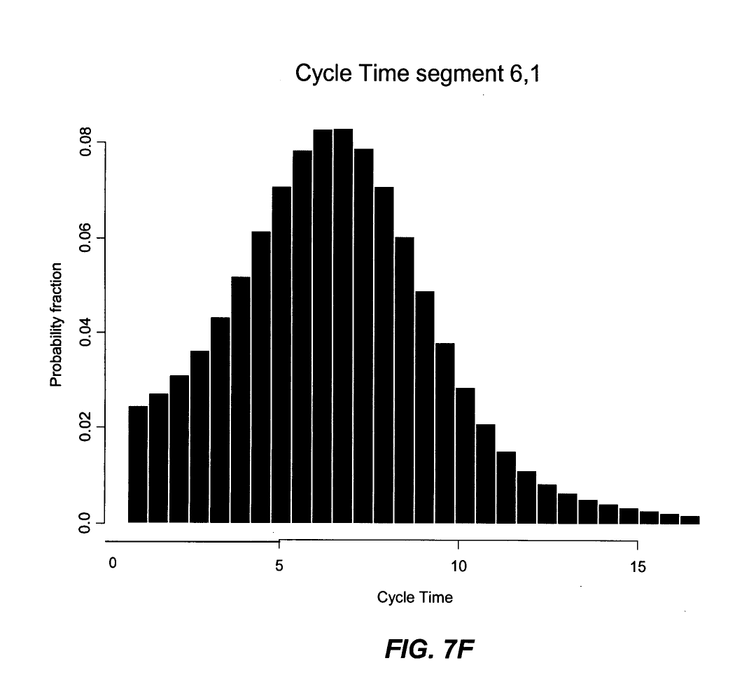

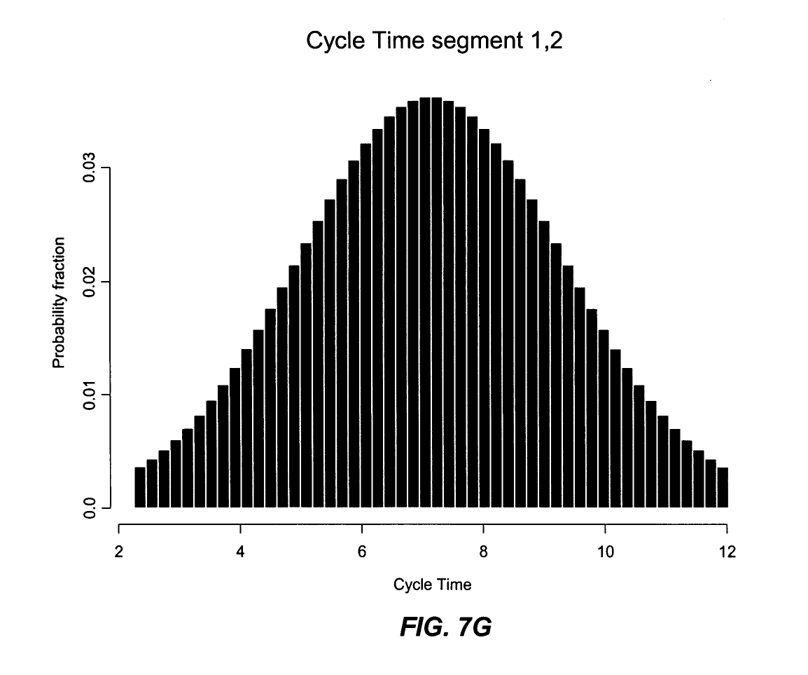

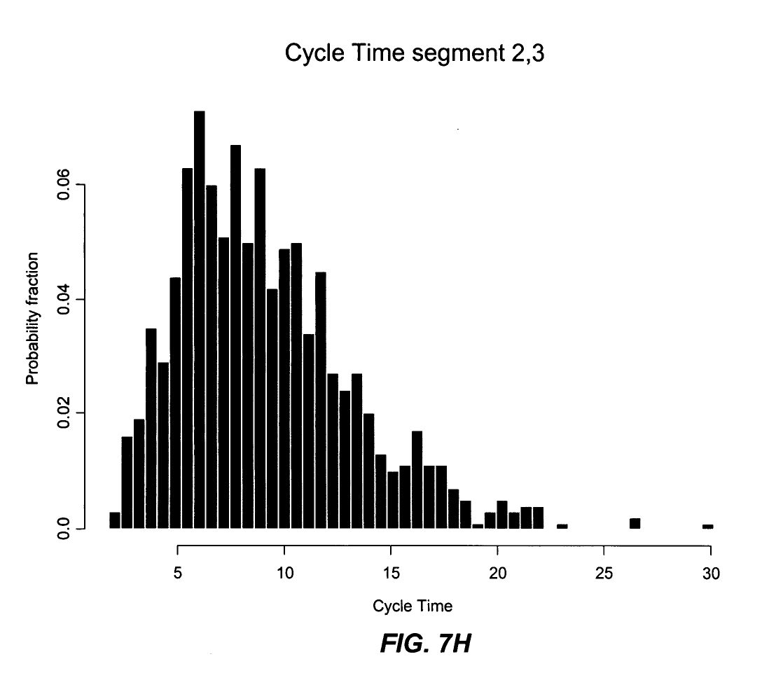

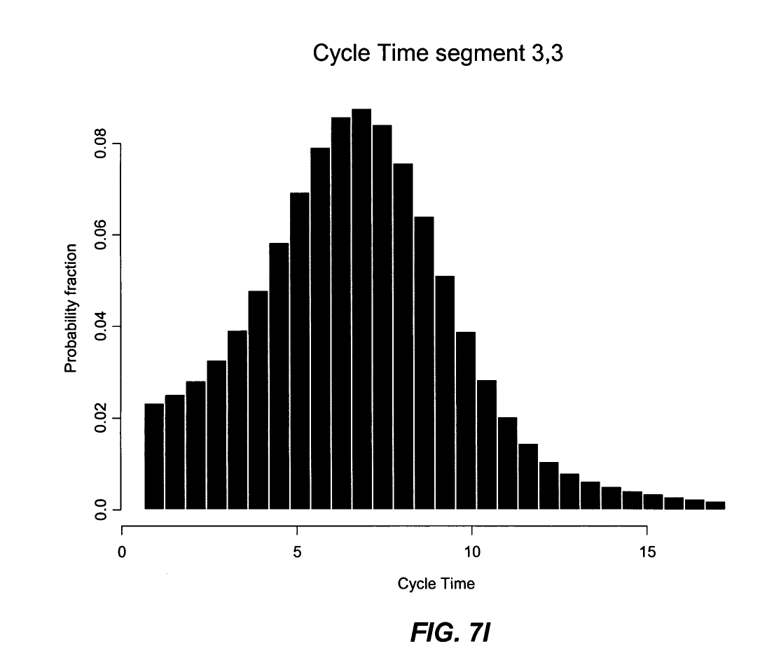

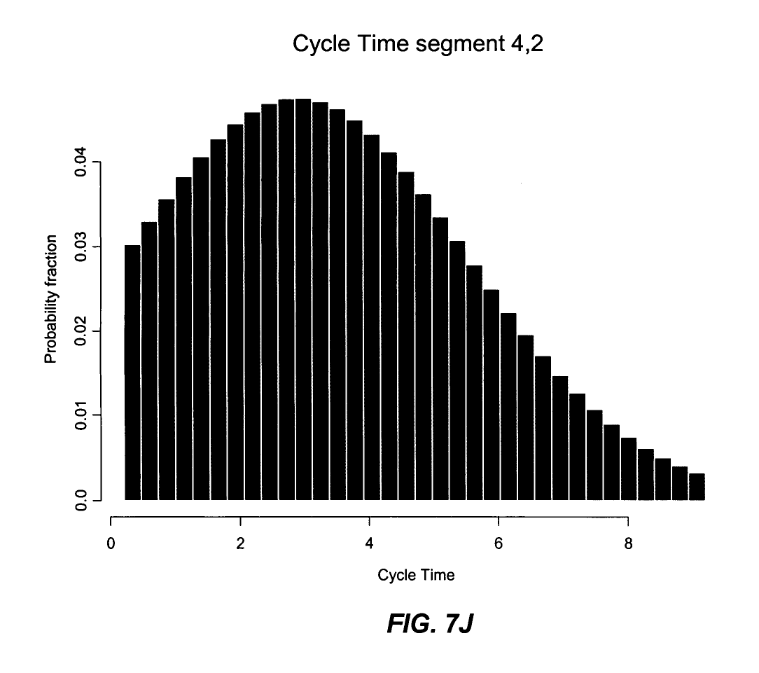

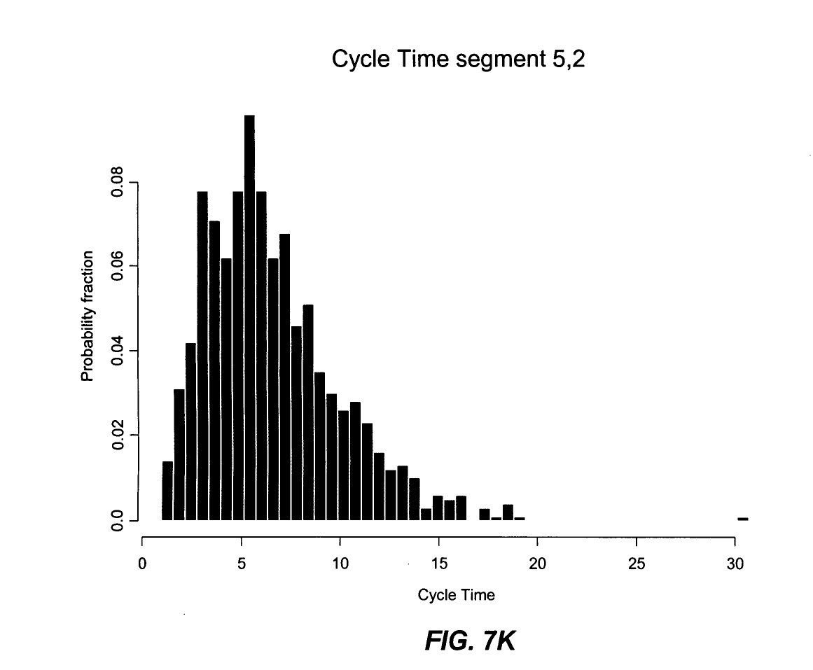

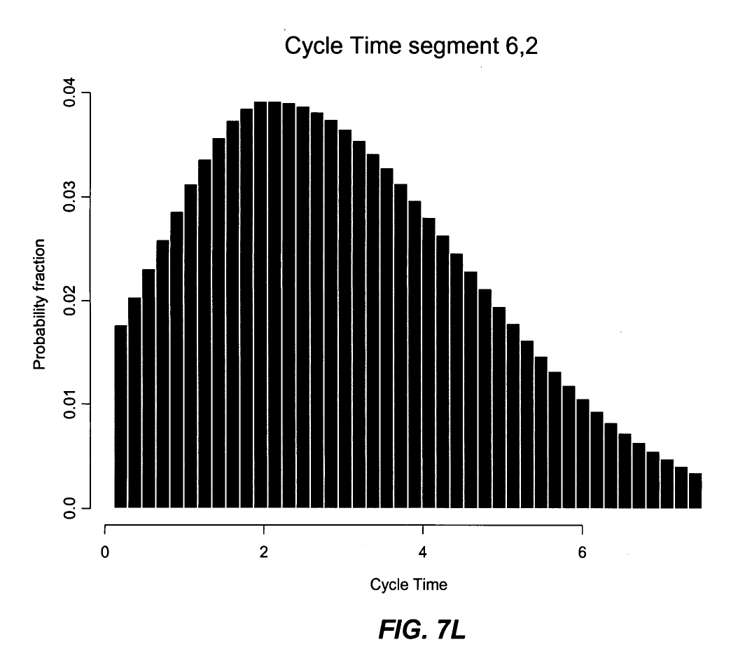

FIGS. 7A-7L graphically illustrate some of the performance models for cycle time associated with the segments in FIG. 6. Specifically, cycle time performance models from two paths are shown (path #1 comprises segments 1,1-5,1 and is represented by FIGS. 7A-7F, while path #13 comprises segments 1,2-5,2 and is represented by FIGS. 7G-7L, as described in Table 4).

While the performance models are shown graphically in FIGS. 7A-7L, it should be noted that the actual implementation is stored in a table structure in the RDBMS 106 similar to Table 4, and that the analytics performed by the Modeling Engine 104 must consider all possible routes (not just the single paths shown). Use of the histogram models in predictive analytics will be discussed in detail in subsequent Sections.

4.2 Segment Combinations

The core functionality of histogram analytics is the combination of segments. There are two possibilities for this combination:
Serial combinations—one segment immediately follows another with no splits or merges in between (sequential skey values).
Parallel combinations—two segments move items equivalent distances in parallel (same skey, different pkey).

These simple combinations are described in detail in the following sections.

4.2.1 Serial Combinations

FIG. 8 illustrates two segments in serial (skey values differ by 1) and their respective histogram models.

Note that the range of possible output values (4 to 12) is consistent with all possible combinations of the input values (2 to 6 twice). The details of performing this calculation are discussed in Section 5.2.2.2.

4.2.2 Parallel Combinations

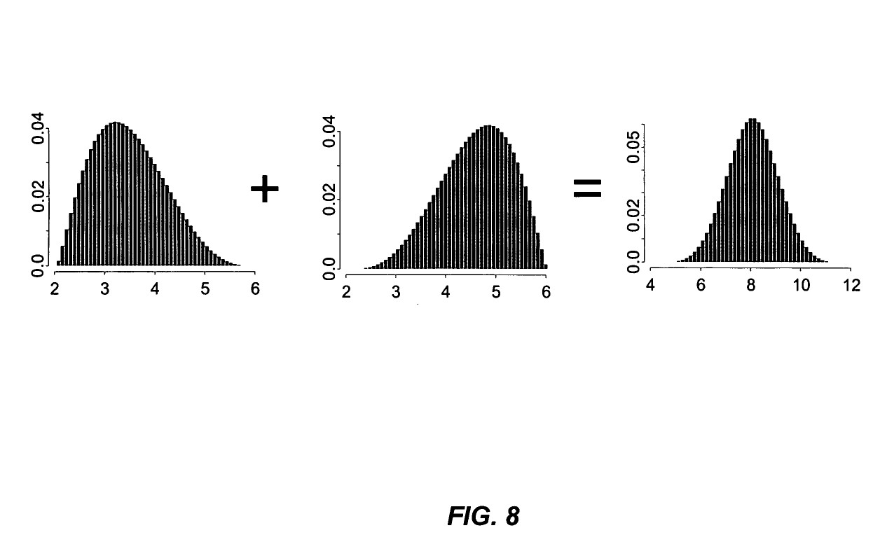

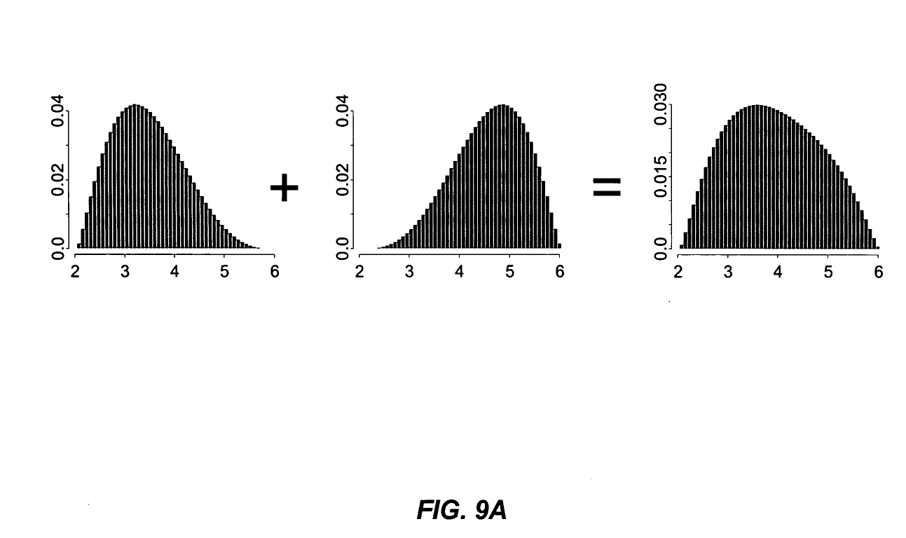

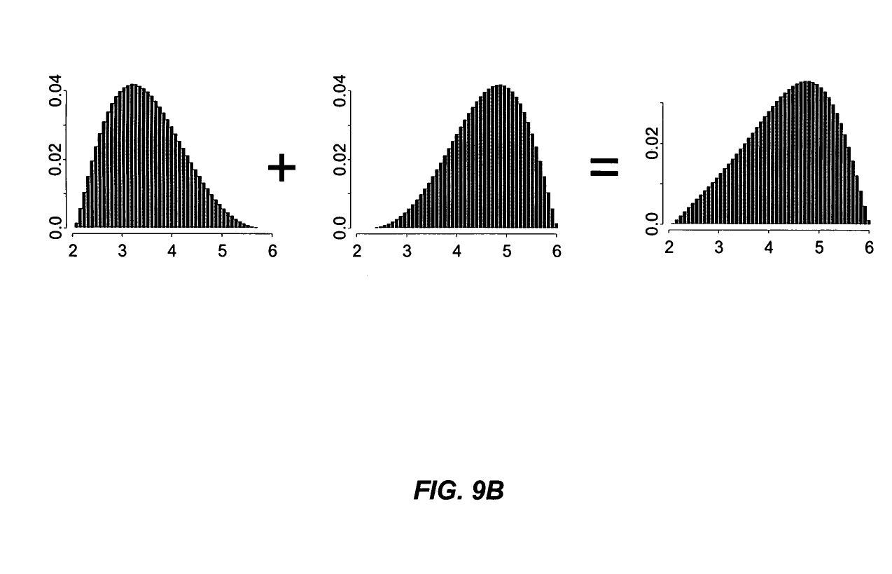

FIGS. 9A and 9B illustrate two segments in parallel (same skey values) and their respective histogram models. Note that parallel combinations require modeling the relative load on each path to properly weight each segments contribution to the cycle time. In FIGS. 9A and 9B, two examples are given with the segments weighted 60/40 (FIG. 9A) and then 20/80 (FIG. 9B).

Note the range on the results is consistent with the input values (2 to 6). The detailed calculations of these results is discussed in Section 5.2.2.3.

4.2.3 Queue Models

Queuing models can be very complex, but in this invention, a simple first in/first out model is used. The cycle time of the queue is then given by the number of items in the queue divided by the throughput of the process emptying the queue. In this document, queues are modeled as a fixed time addition (typically ½ of the subsequent process time, as capacity constraints are not considered herein).

4.2.4 Path Models

Path models in the present invention are kept in their simplest form, i.e., a probability of selecting a path. For example, after finishing a segment, an item may have a 60% probability of one path vs. a 40% probability of another. No additional weights or conditions are considered for the path model in this invention.

5 Predictive Analytics (with Histogram Analytics)

The basis of predictive analytics with histograms is two-fold:
Most statistical descriptors (mean, median, min, max, std. deviation, etc.) can be computed or estimated from histogram representations.
Histograms from distinct processes lend themselves to combination in a structured and repeatable way.

This section describes in detail how these computations can be carried out and used in an example.

5.1 Histogram Calculations

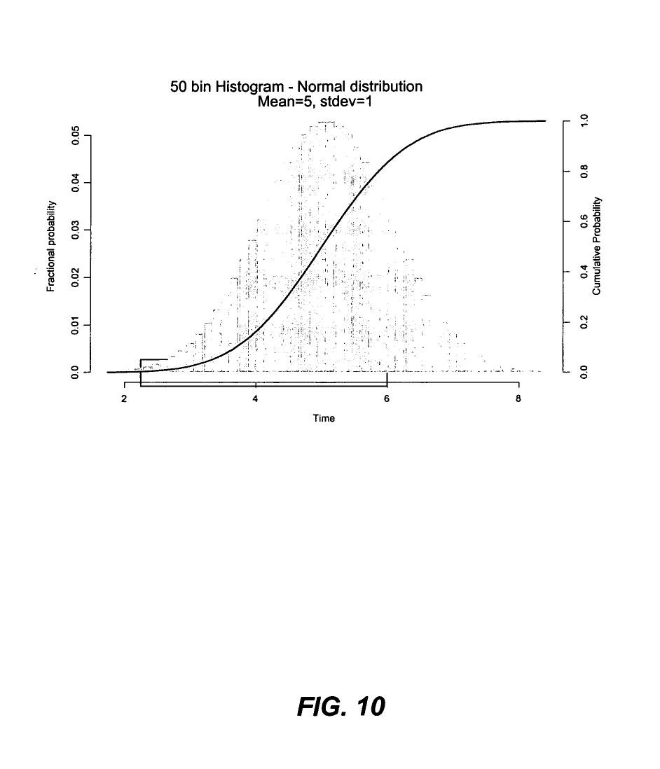

FIG. 10 shows a histogram representing a single segment model (cycle time is shown although the model is equivalent for yield or cycle time). This histogram was generated from a normal distribution with a mean of 5 and a standard deviation of 1. Because the normal distribution is continuous along the x axis, the histogram was truncated at +/−3.5 sigma and renormalized. Superimposed on FIG. 10 is a cumulative probability curve, which is useful for computing statistics and service levels from the model. This figure predicts the probability of observing a range of cycle times and will be used as an example in this section for statistical calculations.

5.1.1 Calculation of the Mean

The mean is easily calculated by summing each bins fractional percent times the bin midpoint, or:

$$\overline{x} = {\sum }_{\# bins} bin . Midpoint \times bin . Percent \qquad ( 1 )$$

which is the expected value of the observations. The bin.Midpoint is the center value of the bin and the bin.Percent is the height of the bin (fractional percent).

5.1.2 Calculation of the Range (Min, Max)

The min and max (and range) are readily calculated by taking the min value of the bins and the max value of the bins:

min Value min(bin.beginning) max Value=max(bin.end) (2)

5.1.3 Calculation of the Median

This calculation is an approximation since the original data values no longer exist. Using the theoretical definition of the median as the 50th percentile of the data, the median can then be estimated from the point on the graph at which the cumulative percentage is equal to 0.50. Note that this may involve interpolation between the bin beginning and bin endpoint.

$$median \approx {b}_{0} + ( {b}_{z} - {b}_{0} ) \frac{( 0.5 - {cp}_{0} )}{( {cp}_{1} - {cp}_{0} )} \qquad ( 3 )$$

where b₀ is the largest bin begin such that the cumulative percentage (cp₀) is <=0.5, and b₁, cp₁ are the bin end and cumulative percentage end, respectively.

5.1.4 Calculation of Arbitrary Quantiles

Equation 3 can be used to compute quantiles of any value (between 0 and 1) by replacing the 0.5 with the desired quantile. For example, the interquartile range (IQR) is computed by subtracting the 25th percentile from the 75th percentile:

IQR=Q₇₅−Q₂₅

5.1.5 Calculation of the Standard Deviation

Standard deviation is also an approximation, as the original data is no longer available (therefore the squared distances can not be computed exactly). Because the min, max and median are known, a “scaling” of intermediate values can be performed to estimate the standard deviation as follows:
Compute the mean using equation (1).
Determine the number of bins and the bin width (bin_delta) for the histogram.
Scale the bin values (by) from bin begin to bin end by:

$$bin\_value ( bv ) = bin\_begin + ( \frac{bin\_number - 1}{\# bins - 1} ) \times bin\_delta$$

A weighted equivalent is used for the standard deviation stdev (where pᵢ represents the bin fraction for bin i):

$$stdev = \sqrt{{\sum }_{\# bins} {p}_{i} ( {bv}_{i}^{2} ) - {mean}^{2}} \qquad ( 4 )$$

For the example of FIG. 10, this equation gives a standard deviation of 1.015, which is approximately 1.5% in error.

Another estimate of standard deviation can be made by noting that the interquartile range for a normal distribution is 1.349 times the standard deviation:

$$stdev\_est = \frac{IQR}{1.349} \qquad ( 5 )$$

where IQR is the interquartle range as calculated in Section 5.1.4. For FIG. 10, this calculation yields a standard deviation of 0.9995, or 0.05% off for the actual value of 1.

5.2 Histogram Projections

Based on current positions, individual segment models and known path probabilities, the statistics of Section 5.1 can be applied to project lead time and yield statistics for future positions. This can be done from any existing location to any location by the following steps:

1. Determine all possible paths between the locations.

2. Aggregate the histogram models for all segments along the possible paths to build a single aggregated histogram.

3. Compute the probability of observing the item at the future location (i.e., the path load percentage). Note that frequently the desired future location is the end of the supply chain. In this case, all paths lead to an end and the probability is 100%.

4. Compute the statistics desired from the resulting histogram (typically any known time or yield in the current segment is offset from this calculation).

This capability allows the prediction of yield, lead times and the most likely paths based on statistical models. Conceptually, the technique is similar to running Monte Carlo simulations and building a histogram to represent the probable outcomes.

This section describes in detail how these projections are constructed.

5.2.1 Path Determination

Many existing algorithms exist for determination of all possible paths. The methodology used in this document is a two pass based on a breadth first search followed by a “synchronizing” pass to align segments into a Cartesian system.

The breadth first search looks for all immediate neighbors connected to a start point. It is repeated recursively until all end points are found.

The result is similar to Table 4 in that each path is uniquely identified.

The path table is primarily used to determine path loads for segment aggregation weights (Section 5.2.2) and to determine possible paths between two points.

5.2.2 Segment Aggregations

The most complex part of the projections is building the single aggregated histogram to represent all likely paths for a shipment or product. As items move in the supply chain, the calculations must be repeated to update the aggregated model.

For example, to determine the expected end time for a shipment current in segment 2,2 (FIG. 5), the aggregation routine must aggregate all possible paths from 2,2 to all possible end points. The next day, the item might be observed in queue 4.3, which means that the aggregation must be recalculated for all paths to the end from 4,3.

The methodology for this can be outlined as follows (and is discussed in detail in the sections below).

1. Determine end point(s). The existing model for the end point segments is the same as the aggregated model (e.g., an item in an end point segment can only exit the segment (Section 5.2.2.1)).

2. From the endpoint, determine next segments (upstream) and path loads connected to endpoints.
a. Perform serial combinations of end segments and connected segments (Section 5.2.2.2).
b. Perform parallel combinations of previous aggregations as required by merges (Section 5.2.2.3).

The result is the aggregated histogram for the segments once removed from the end points.

3. Repeat previous steps (treating aggregated result as the new end point) until the start segments are found.

This methodology creates an aggregated histogram for all the segments in the path (that are connected to the destination segment).

To compute different destinations, the process may be repeated or a segment subtraction can be performed.

5.2.2.1 End Point Determination

End segments must be marked with a “sentinel” (a 0 in table 1). These are used to determine the end points and will utilize the existing segment model as the projection.

Example: Referring to FIG. 5 and Table 1, the end point segments are identified as segments 6,1 and 6,2. The performance models (from Table 2 and FIGS. 7A-7L) are copied as the projection models. Any item currently in segments 6,1 or 6,2 will use these models and the analytics described in Section 5.1 for projections.

5.2.2.2 Serial Segment Combination

The method for combining two segments that follow one another serially is:

1. If one of the segments includes a queue, the queue time is added as a constant to all of the non-queue segment bins (equivalent to a shift along the x axis).

2. If one of the segments is a null segment, the output segment is the same as the non-null input segment.
Else:

3. Add min values to determine new min value.

4. Add max values to determine new max values.

5. Determine new histogram bins by dividing range from new_min to new_max into equal sized bins (typically 50). This (empty) histogram is referred to as the skeleton histogram.

6. Form a cross product type of addition of all bins in two serial segments. If each histogram has 50 bins, this step will produce 2500 bin combinations (50×50). This is referred to as the merge histogram.

7. Form an equivalent cross product of the probabilities associated with each of the combination bins (2500 for two 50 bin histograms), which is referred to as the merge percentage.

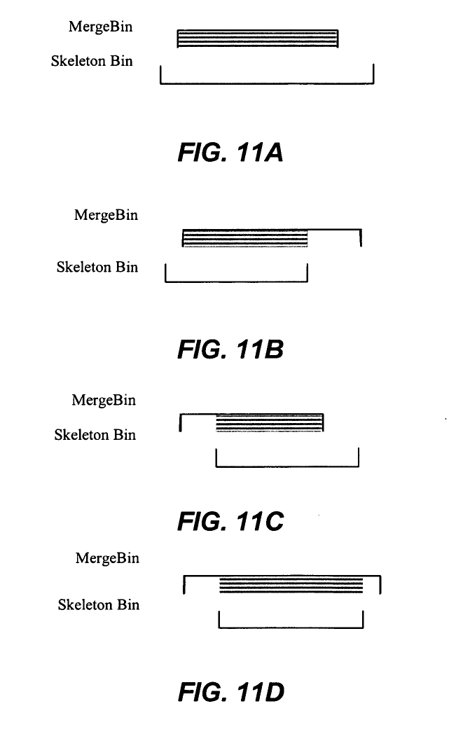

8. For each bin in the skeleton histogram (e.g., 50 bins) distribute the probabilities (i.e., rebin) proportionately to the amount of overlap merge bins. Note that there are typically four possibilities for overlap, as described below and in FIGS. 11A-D (where the shaded portion of the Merge Bin represents the fraction of the percentage added from the bin):
In FIG. 11A, the Merge Bin is totally contained within the Skeleton Bin. In this case, the entire bin percent from the Merge Bin is added (cumulatively) to the Skeleton Bin.
In FIG. 11B, the Merge Bin starts within the Skeleton Bin, but ends one or more bins above. In this case, the shaded portion of the Merge Bin is added to the Skeleton Bin.
In FIG. 11C, the Merge Bin starts before the Skeleton Bin, but ends within the Skeleton Bin. In this case, the shaded fraction of the Merge Bin is added to the Skeleton Bin.
In FIG. 11D, the Merge Bin spans the Skeleton Bin. In this case, the shaded portion of the Merge Bin corresponding to the width of the Skeleton Bin is added to the Skeleton Bin.

Note that the comparisons are always left based (i.e., <=or >=) when referring to a left edge of a bin. This avoids duplicate counting when a Merge Bin end aligns exactly with a Skeleton Bin.

9. Determine if any leftmost or rightmost bins are less than the target minimum percentage as specified by the user and/or application (e.g., <1E-7). If so, these bins are removed.

10. Verify the histogram probabilities sum to 1 and renormalize if necessary.

The resulting segment may be the final segment for the leftmost location, or additional aggregations may be necessary to handle parallel paths from merges.

Example: Referring to FIGS. 6 and 7A-7L, there are three serial combinations that must be made:
Segment 6,1 with segment 5,1 (cumulative path load of 40.125%).
Segment 6,2 with segment 5,2 (cumulative path load of 47.375%).
Segment 6,2 with segment 5,3 (cumulative path load of 12.5%).

Consider the following example for segment 6,1 with segment 5,1:
Using the example from FIGS. 6 and 7A-7L for 6,1 with 5,1, the min values are 0.483 for segment 6,1, and 5.389 for segment 5,1. This gives a new min value of 5.87.
The current max values for segment 6,1 and 5,1 are 16.47 and 13.96 respectively. The skeleton histogram has a new max of 30.43.
The skeleton histogram is then formed with 50 bins ranging from 5.87 to 30.43 (bin width=0.491).
2500 Merge Bins are then formed by adding the bin_beginning for each bin in 5,1 to the bin_beginning for each bin in 6,1. Similarly, the bin_ends are added to bound the bins.
2500 Merge Bin probabilities are formed by multiplying each bin_percentage from 5,1 by the bin percentage for 6,1.
The probabilities computed above are then rebinned by adding the fraction of the probability equivalent to the bin overlap according to the previous rules. For example, bin 2 of the Skeleton Bin has the following bin_begin and bin_end values:

bin_begin=6.363

bin_end=6.854

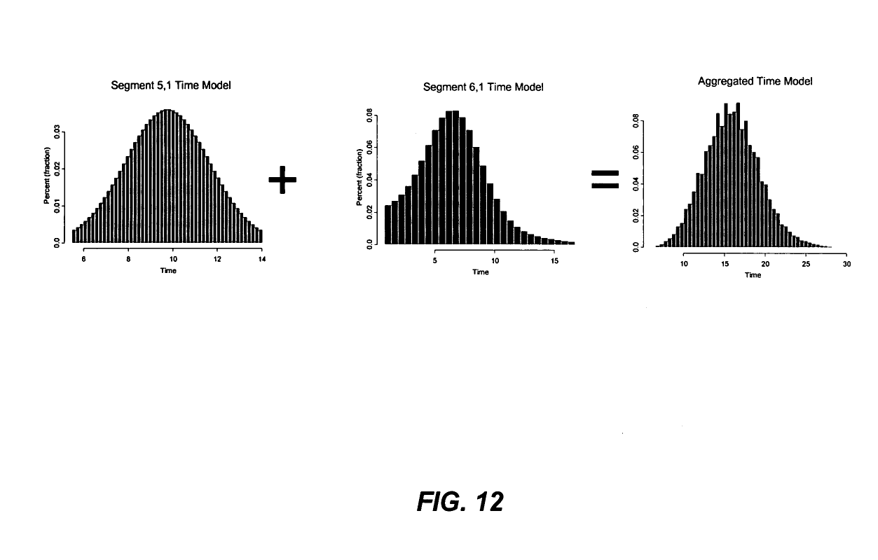

Of the 2500 bins formed in the cross product, there are 9 merge segments that overlap some or all of this segment. Summing the product percentages for these 9 merge segments (proportional to the overlap) yields a total percentage of 0.106%.
This is repeated to build all 50 bin percentages in the skeleton histogram. The results are illustrated in FIG. 12.

Whenever serial combinations are necessary, this process is repeated.

5.2.2.3 Parallel Segment Combination

When it is necessary to combine two segments in parallel, the following steps are performed:

1. Determine the minimum bin_begin of both histograms. This is the new minimum of the resulting (skeleton) histogram.

2. Determine the maximum bin_end of both histograms. This is the new maximum of the skeleton histogram.

3. Build the skeleton histogram by dividing the range (bin_begin to bin_end) into equal sized bins (typically 50). This (empty) histogram is referred to as the skeleton histogram.

4. Multiply the bin_percentage values of each source histogram by the relative path loading. For example, if one parallel path contains 60% of the load, all the percentages for that histogram are multiplied by 0.6.

5. Add the resulting percentages of each of the component histogram bins to the skeleton histogram using the same proportionality as outlined in Section 5.2.2.2 for bin overlapping.

6. Compare the resulting bins to the min_percentage specified by the user or application and remove edge bins below the min_percentage. Renormalize if necessary.

Example: Referring to FIGS. 6 and 7A-7L, an item in segment 3,2 going to 6,2 has two parallel paths that can be taken:
From 3,2 to 4,2 to 5,2 to 6,2 (40% load).
From 3,2, to 4,3 to 5,3 to 6,2 (20% load).

This suggests that the aggregated segments represented by the serial combination of 4,2 be combined with the aggregated segments of 4,2 in parallel.

Technically, this aggregation is “out of context,” as it is not considering the other paths (e.g., 3,3 to 4,3 or 3,1 to 4,2). It is shown here for illustration only.

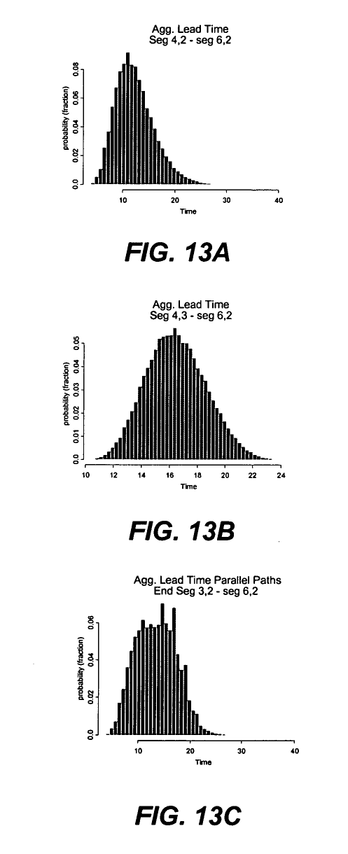

FIGS. 13A-13C show the results of combining the two serial aggregations (note the queue was modeled as ½ the cycle time of the depended segment). FIG. 13A shows the aggregated time for segments 4,2, 5,2 and 6,2 combined serially, and FIG. 13B shows the aggregated time for segments 4,3, 5,3 and 6,2 combined serially. The resulting aggregates of FIGS. 13A and 13B are then combined in parallel, resulting in the FIG. 13C.

5.2.3 Algorithm for Combinations

With the tools described for aggregating histograms both serially and parallel, a recursive algorithm can be performed by the Modeling Engine 104 to combine segment models. This is generally done by starting at the end point and combining segments “upstream.” This has the added advantage of allowing storage of intermediate results that are useful for predicting the endpoint.

The following steps describe the sequential aggregations performed by the Modeling Engine 104 to generate predictive histograms for each segment to the end of the supply chain.

1. Models for the segments 6,1 and 6,2 are copied as models for output.

2. Histogram models are built for segments 4,1 (queue/process) to the end points. Additional histograms are built for 4,2 and 4,3. These segments are built through serial combinations with 6,1 and 6,2.

3. Histogram models are built for segments 3,1 to the end, 3,2 to the end, and 3,3 to the end. The segment 3,1 is built through parallel combination (4,2 and 5,2 to the end) followed by a serial combination. The segments 3,2 and 3,3 are built in an analogous manner, i.e., serial, parallel, and then serial combinations.

4. Segments 2,1 and 2,3 (blue) connect to null segment, so identical distribution to 3,1 and 3,3. Segment 2,2 to end formed by serial combination w/aggregation of 3,2.

5. Segments 1,1 and 1,2 are formed through parallel aggregation of composite segments 2,1 to the end, 2,2 to the end, and 2,3 to the end.

6. The total combination (of the entire supply chain) can then be built using a parallel combination of segments 1,1 and 1,2 (with 50% weights) as shown.

### LOGIC OF THE PREFERRED EMBODIMENT

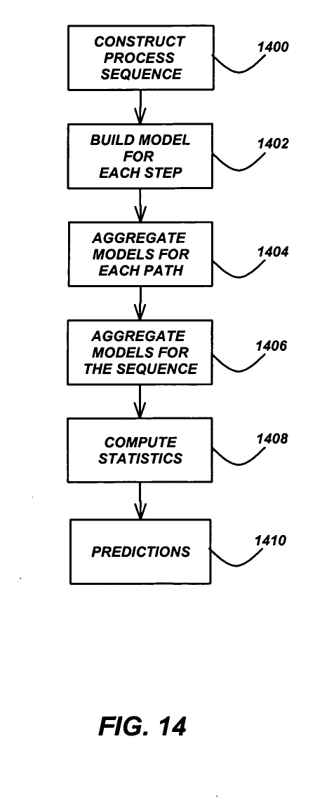

FIG. 14 is a flow chart illustrating the logic of the preferred embodiment of the present invention. Those skilled in the art will recognize that this logic is provided for illustrative purposes only and that different logic may be used to accomplish the same results. Moreover, the various aspects of the logic may be performed by one or more of the Client 102, Modeling Engine 104, RDBMS 106, Parsing Engine 110 and/or Access Module Processors 112A-112E.

Block 1400 represents the step of constructing the process sequence, wherein the process sequence includes one or more paths comprising one or more steps connecting the process sequence start with the process sequence finish.

Block 1402 represents the step of building at least one histogram model for each step, wherein the histogram models for each step comprise models for cycle time or yield. This is described further in co-pending and commonly-assigned U.S. patent application Ser. No. 10/742,966, filed on Aug. 9, 2004, by Bruce E. Aldridge and Rangarajan S. Thirumpoondi, entitled “System and Method for Tuning a Segmented Model Representing Product Flow Through a Supply Chain or Manufacturing Process,” attorneys' docket no. 11408, which application is incorporated by reference herein.

Block 1404 represents the step of combining the histogram models for each step into an aggregated histogram model for each path. Each path may include one or more relative probabilities of taking that path and the aggregated histogram models for each path include the relative probabilities of taking that path. The histogram models may be combined in serial when one step of a path immediately follows another step of the path with no splits or merges in between. Alternatively, the histogram models may be combined in parallel when two steps of a path move items equivalent distances in parallel. When the histogram models are combined in parallel, a relative load is used on each segment to properly weight each step's contribution to the combination.

Block 1406 represents the step of combining the aggregated histogram models for each path into an aggregated histogram model for the process sequence.

Block 1408 represents the (optional) step of computing statistics from the histogram models for each step, the aggregated histogram models for each path, or the aggregated histogram model for the process sequence.

Block 1410 represents the (optional) step of predicting path, time or quantity in the process sequence using the histogram models for each step, the aggregated histogram models for each path, or the aggregated histogram model for the process sequence.

### CONCLUSION

This concludes the description of the preferred embodiment of the invention. The following paragraphs describe some alternative embodiments for accomplishing the same invention.

In one alternative embodiment, any type of computer or configuration of computers could be used to implement the present invention. In addition, any database management system, analytical application, or other computer program that performs similar functions could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for modeling a process sequence in a computer, comprising:
(a) constructing the process sequence, wherein the process sequence includes one or more paths comprising one or more steps connecting the process sequence start with the process sequence finish;
(b) building at least one histogram model for each step;
(c) combining the histogram models for each step into an aggregated histogram model for each path; and
(d) combining the aggregated histogram models for each path into an aggregated histogram model for the process sequence.

2. The method of claim 1, wherein the histogram models for each step comprise models for cycle time or yield.

3. The method of claim 1, wherein each path includes one or more relative probabilities of taking that path and the aggregated histogram models for each path include the relative probabilities of taking that path.

4. The method of claim 1, wherein the histogram models are combined in serial when one step of a path immediately follows another step of the path with no splits or merges in between.

5. The method of claim 1, wherein the histogram models are combined in parallel when two steps of a path move items equivalent distances in parallel.

6. The method of claim 1, wherein the histogram models are combined in parallel using a relative load on each segment to properly weight each step's contribution to the combination.

7. The method of claim 1, further comprising computing statistics from the histogram models for each step, the aggregated histogram models for each path or the aggregated histogram model for the process sequence.

8. The method of claim 1, further comprising predicting path, time or quantity in the process sequence using the histogram models for each step, the aggregated histogram models for each path or the aggregated histogram model for the process sequence.

9. An apparatus for modeling a process sequence, comprising:
a computer;
a Modeling Engine Framework, performed by the computer, for:
(a) constructing the process sequence, wherein the process sequence includes one or more paths comprising one or more steps connecting the process sequence start with the process sequence finish;
(b) building at least one histogram model for each step;
(c) combining the histogram models for each step into an aggregated histogram model for each path; and
(d) combining the aggregated histogram models for each path into an aggregated histogram model for the process sequence.

10. The apparatus of claim 9, wherein the histogram models for each step comprise models for cycle time or yield.

11. The apparatus of claim 9, wherein each path includes one or more relative probabilities of taking that path and the aggregated histogram models for each path include the relative probabilities of taking that path.

12. The apparatus of claim 9, wherein the histogram models are combined in serial when one step of a path immediately follows another step of the path with no splits or merges in between.

13. The apparatus of claim 9, wherein the histogram models are combined in parallel when two steps of a path move items equivalent distances in parallel.

14. The apparatus of claim 9, wherein the histogram models are combined in parallel using a relative load on each segment to properly weight each step's contribution to the combination.

15. The apparatus of claim 9, further comprising computing statistics from the histogram models for each step, the aggregated histogram models for each path or the aggregated histogram model for the process sequence.

16. The apparatus of claim 9, further comprising predicting path, time or quantity in the process sequence using the histogram models for each step, the aggregated histogram models for each path or the aggregated histogram model for the process sequence.

17. An article of manufacture tangibly embodying logic for modeling a process sequence in a computer, the logic comprising:
(a) constructing the process sequence, wherein the process sequence includes one or more paths comprising one or more steps connecting the process sequence start with the process sequence finish;
(b) building at least one histogram model for each step;
(c) combining the histogram models for each step into an aggregated histogram model for each path; and
(d) combining the aggregated histogram models for each path into an aggregated histogram model for the process sequence.

18. The article of claim 17, wherein the histogram models for each step comprise models for cycle time or yield.

19. The article of claim 17, wherein each path includes one or more relative probabilities of taking that path and the aggregated histogram models for each path include the relative probabilities of taking that path.

20. The article of claim 17, wherein the histogram models are combined in serial when one step of a path immediately follows another step of the path with no splits or merges in between.

21. The article of claim 17, wherein the histogram models are combined in parallel when two steps of a path move items equivalent distances in parallel.

22. The article of claim 17, wherein the histogram models are combined in parallel using a relative load on each segment to properly weight each step's contribution to the combination.

23. The article of claim 17, further comprising computing statistics from the histogram models for each step, the aggregated histogram models for each path or the aggregated histogram model for the process sequence.

24. The article of claim 17, further comprising predicting path, time or quantity in the process sequence using the histogram models for each step, the aggregated histogram models for each path or the aggregated histogram model for the process sequence.
